(19) United States
(12) Patent Application Publication
(10) Pub. No.: US 2003/0207664 A1
(43) Pub. Date: Nov. 6, 2003

(54) Device for integrating a vacuum pumping system in a clean room false floor of a semiconductor component manufacturing plant

(75) Inventor: Michel Quinet, Naves-Parmelan (FR)

Correspondence Address: SUGHRUE MION, PLLC, 2100 PENNSYLVANIA AVENUE, N.W., WASHINGTON, DC, 20037, US

(73) Assignee: ALCATEL

(21) Appl. No.: 10/426,792

(22) Filed: May 1, 2003

(30) Foreign Application Priority Data
May 2, 2002 (FR) 02 05516

(51) Int. Cl. B01L 1/04; E04C 2/52; E04B 1/00; E04B 5/00; E04B 7/00

(52) U.S. Cl. 454/187; 52/220.1; 52/263

(57) ABSTRACT

According to the invention, vacuum pumping systems are integrated in the intermediate space between a supporting slab and a clean room false floor formed from a juxtaposition of false floor tiles held by posts resting on the supporting slab. A platform, whose size is greater than the floor space requirement of the vacuum pumping system to be integrated, and substantially equal to that of a false floor tile, is held away from the supporting slab by feet resting on the supporting slab. Thus part of the space underneath the vacuum pumping systems is freed, for the free passage of cables and ducts. Simultaneously the vacuum pumping system is isolated with respect to the false floor, in order to avoid the transmission of vibrations.

The present invention relates to the means making it possible to integrate at least in part a vacuum pumping line in the intermediate space situated between a supporting slab and a clean room false floor in a semiconductor component manufacturing plant.

The floor of the clean room of a semiconductor component manufacturing plant generally consists of a false floor surmounting a 90 cm-thick concrete supporting slab pierced at regular intervals by holes which are 80 cm long and 40 cm wide. The holes are used for passing ducts and cables to the basement.

On this supporting slab there are fixed, with a 60 cm mesh, jack feet of variable height depending on the plant, and on which there rest 60 cm×60 cm perforated false floor tiles made of aluminium. The height of the jack feet can vary between approximately 43 cm and approximately 120 cm, depending on the plant. On the false floor tiles there are placed the items of semiconductor component manufacturing equipment. In the volume under the false floor tiles there pass the various ducts and cables necessary for the operation of the equipment placed on the false floor constituted by the false floor tiles.

A proposal has recently been made, for example in the document WO 01/82019, to integrate, in the intermediate space between the supporting slab and the false floor, at least part of the vacuum line, for example a vacuum pumping system consisting of a primary pump possibly with related devices for treatment of pumped gases.

The invention aims to capitalise on the main advantages of an integration of the vacuum pumping system in the space between the slab and the false floor:

improvement of the useful pumping capacity, through closeness of the pump and the vacuum chambers situated in the clean room;

saving of space in the basements where the vacuum pumps are traditionally installed;

saving of pumping line, which is long and sometimes heated, from the basement to the machine.

But the presence of a vacuum pumping system in the intermediate space between the supporting slab and the false floor interferes with the passage of the cables and ducts, and risks generating vibrations which are transmitted to the false floor and interfere with the operation of the equipment placed on the false floor. These vibrations are particularly harmful in the case where the equipment is used for semiconductor component manufacture, since they are a source of pollution of the semiconductor wafers being processed.

The invention thus also aims to avoid the drawbacks which can result from the space requirement of the vacuum pumping system in the intermediate space between the supporting slab and the false floor for the passage of cables and ducts, and to avoid the problems related to possible vibrations of the vacuum pumping system.

For this, the idea which is at the root of the invention consists of supporting the vacuum pumping system by an intermediate support platform, which frees a portion of space underneath the vacuum pumping system for the passage of cables and ducts, and which mechanically isolates the vacuum pumping system with respect to the false floor.

To achieve these aims, as well as others, the invention thus provides a device for the integration of a vacuum pumping system in the intermediate space between a supporting slab and a clean room false floor formed from a juxtaposition of false floor tiles held by false floor tile support posts resting on the supporting slab, comprising:

a platform, whose size is greater than the floor space requirement of the vacuum pumping system to be integrated and substantially equal to that of a false floor tile;

means for holding the platform, parallel and away from the supporting slab, and at a distance from the false floor by a height greater than the height of the vacuum pumping system to be integrated.

The fact that the vacuum pumping device is thus supported under the false floor tiles makes it possible to save space in the clean room, whilst simultaneously leaving a free space underneath the platform, a space sufficient for passing the ducts and cables necessary for the operation of the equipment placed on the false floor.

Two types of support means are defined for holding the platform.

According to a first embodiment, the platform is held up in position by four support blocks each having a jaw gripping a false floor tile support post and having a connecting part gripping the platform.

For example, the connecting part can comprise a shaft protruding vertically upwards and fitting into a corresponding lower housing of the platform.

The corresponding lower housing of the platform can be a simple hole formed in the central branch of a U-section fixed on the under-face of the platform.

Preferably, the platform comprises, for its being kept in position by four support blocks, three oblong holes and one round hole. In this way, the platform can be correctly positioned irrespective of any positioning faults of the false floor tile support posts, or of the other platform support means.

According to one advantageous embodiment, avoiding the transmission of vibrations, each support block comprises an elastic and damped intermediate link, which opposes the transmission of vibrations from the vacuum pumping system to the false floor.

According to a second embodiment, the platform is held up by four feet which are independent of the means of holding up the false floor tiles and which rest on the supporting slab.

In this case, the feet preferably have length-adjustment means, for adapting the vertical position of the platform.

In the two embodiments, the platform can advantageously be continuous and have a continuous upper peripheral rim, the whole constituting a liquid retaining tank. The platform can then be associated with a humidity detector, which makes it possible to detect a liquid flow in order to generate an alarm or instructions for controlling equipment in the clean room.

Preferably, the platform bears a polymer mat, interposed between the platform and the vacuum pumping system, and further reducing the transmission of vibrations from the vacuum pumping system to the false floor.

According to another aspect, the device of the invention also comprises a mobile lifting frame, with four support legs having directional castors and having a height greater than that of a vacuum pumping system to be integrated, and with two cross members with slide rails on which there slides a movable carriage carrying a winch.

Preferably, the winch acts on a cable which carries a T-shaped linking component, connected by its adjustable central area to the end of the cable, and having fixing holes at the ends of its branches for attaching the vacuum pumping system.

The mobile lifting frame makes it possible on the one hand to position the vacuum pumping devices on their platform, and on the other hand to remove them from the space between the slab and the false floor, under the best safety conditions.

According to another aspect, the invention makes provision for a semiconductor manufacturing plant, comprising a clean room with a false floor and a supporting slab and a vacuum pumping system; the vacuum pumping system is supported by an intermediate support platform in the intermediate space between the supporting slab and the false floor, freeing a portion of space underneath the vacuum pumping system for the passage of cables and ducts and mechanically isolating the vacuum pumping system with respect to the false floor.

Other objects, characteristics and advantages of the present invention will emerge from the following description of particular embodiments, given in connection with the accompanying figures, amongst which:

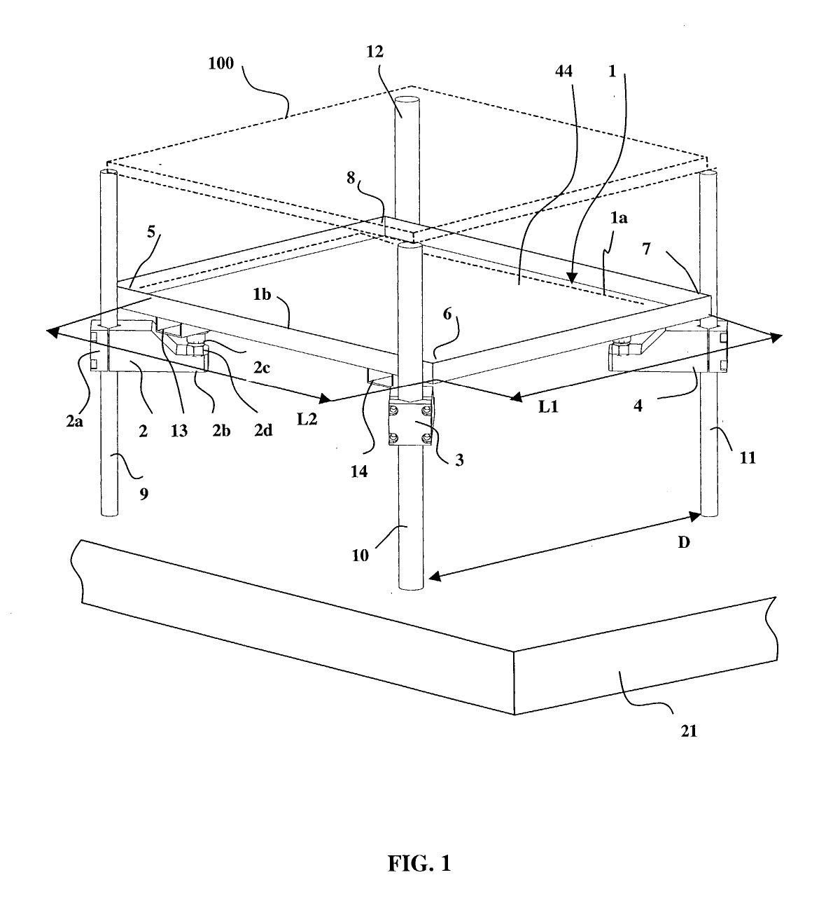

FIG. 1 is a perspective view illustrating the integration device according to a first embodiment of the present invention;

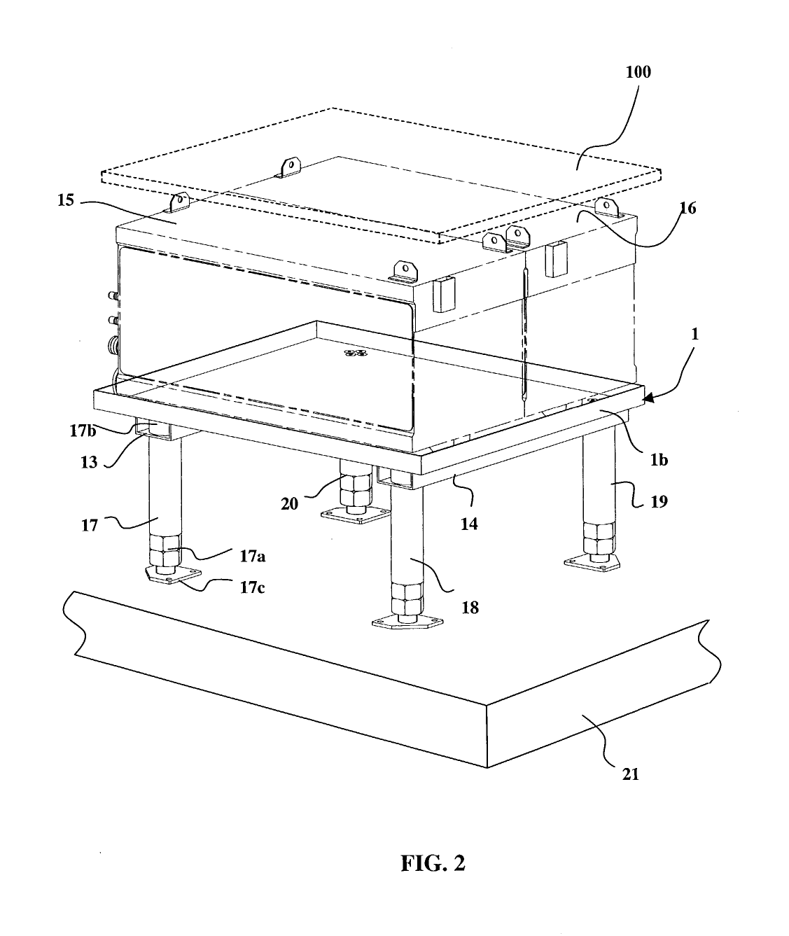

FIG. 2 is a perspective view of an integration device according to a second embodiment of the invention, supporting two vacuum pumping systems;

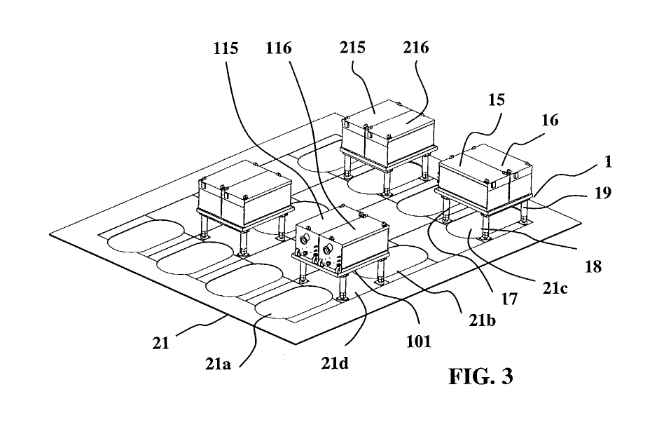

FIG. 3 is a perspective view illustrating the possible positions of vacuum pumping units on a supporting slab;

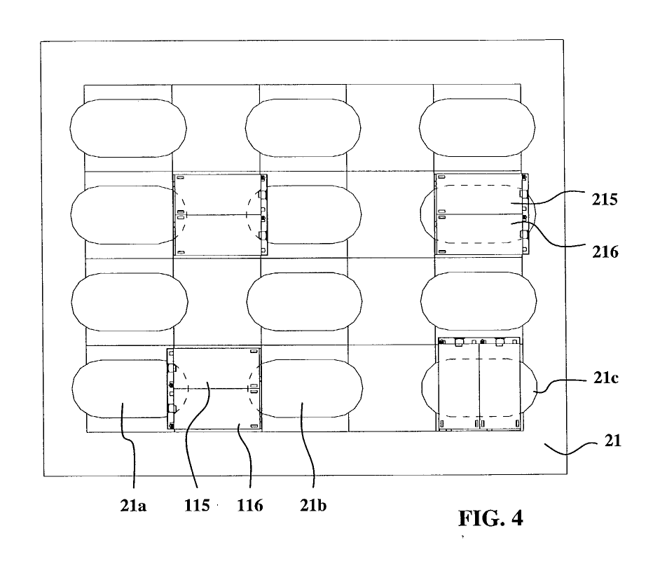

FIG. 4 is a top view illustrating the relative position of false floor tiles, openings in the supporting slab, and platforms supporting the vacuum pumping systems; and

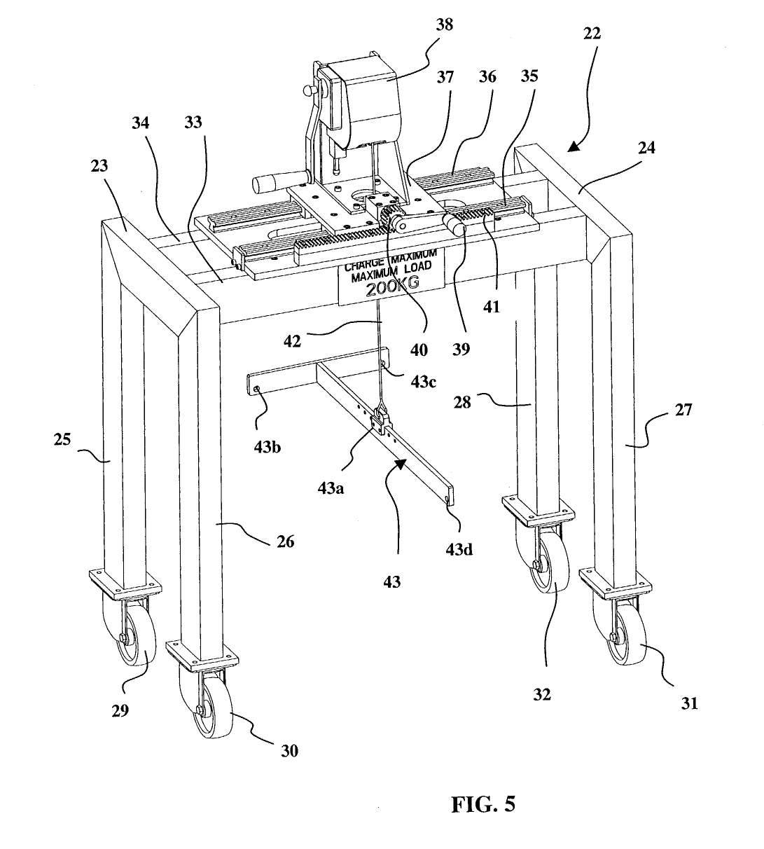

FIG. 5 is a perspective view of a mobile lifting frame according to one embodiment of the invention.

In the embodiment illustrated in FIG. 1, the device for integrating a vacuum pumping system comprises a rectangular platform 1, whose dimensions are greater than the floor space requirement of the pumping system to be integrated, these dimensions being substantially equal to those of a false floor tile 100. The platform 1 is held up in position by four support blocks, such as the support blocks 2, 3 and 4, disposed in the vicinity of four respective corners 5, 6, 7 and 8 of the rectangular platform 1.

Each support block such as the support block 2 comprises a jaw 2a gripping a respective false floor tile support post such as the posts 9, 10, 11 and 12 resting on the concrete supporting slab 21. The support block 2 comprises a connecting part 2b gripping the platform 1.

The connecting part 2b comprises a shaft 2c which protrudes vertically upwards in order to fit into a corresponding lower housing of the platform 1.

The support block 2 also comprises an elastic and damped intermediate link, which opposes the transmission of vibrations between the platform 1 and the corresponding false floor tile support post 9. For example, the elastic and damped intermediate link is a Silentbloc 2d disposed between the body of the support block 2 and the shaft 2c.

According to one advantageous embodiment, being inexpensive and effective, the platform 1 comprises two U-sections 13 and 14, fixed to the under-face of the platform 1, the central branch of which is situated away from the platform 1 to which it is connected by the two side branches. The lower housing intended to receive the shaft 2c of the support block 2 is then a simple hole provided in the central branch of the U-section 13.

In the embodiment illustrated in FIG. 1, the platform 1 is kept in position by the three visible support blocks 2, 3 and 4 and by the fourth block, not visible in the figure. For this, the platform 1 comprises three oblong holes and one round hole, receiving the respective shafts of the four blocks.

As can be seen clearly in FIG. 1, the platform 1 comprises a continuous sheet 1a edged with a continuous upper peripheral rim 1b, the whole constituting a liquid retaining tank.

Although other shapes are possible and in accordance with the invention, the platform 1 advantageously has a rectangular shape, with a width L1 slightly less than the distance D between two successive false floor tile support posts 10 and 11, whilst its length L2 is greater than the distance D.

For example, the platform 1 has a size of approximately 650×560 mm.

In the second embodiment, illustrated for example in FIG. 2, a number of elements of the platform of FIG. 1 are found again, and these elements are indicated by the same numerical references. There can thus be found again the rectangular platform 1 with its continuous upper peripheral rim 1b, its two U-sections 13 and 14 which themselves have the passageway holes for vertical keeping-in-position shafts.

This figure depicts two vacuum pumping systems 15 and 16 disposed side by side on the platform 1.

The platform 1 is held up by four feet, respectively 17, 18, 19 and 20, which are independent of the means of holding up the false floor tiles 100, and which rest directly on the supporting slab 21. The feet 17-20 have length-adjustment means, for example screw jacks 17a, for adapting the vertical position of the platform 1 with respect to the supporting slab 21. Each foot 17-20 has an upper end having a vertical shaft 17b fitted into one of the holes provided in the U-sections 13 or 14 of the platform 1. Each foot 17-20 has at its base a fixing plate such as the plate 17c, which is fixed by screwing or any other means onto the supporting slab 21.

The feet 17-20 are disposed in a square which is smaller in size than the platform 1. For example, for a platform approximately 650×560 mm in size, the feet are disposed in a square with a side of approximately 480 mm, and in a position off-centred with respect to the rectangle constituted by the platform 1.

The square formed by the four feet 17-20 is substantially centred as regards the width of the platform 1, but off-centred as regards the length.

In the two embodiments, the platform 1 advantageously bears a polymer mat 44 (FIG. 1), interposed between the platform 1 and the vacuum pumping system or systems 15, 16 (FIG. 2).

FIGS. 3 and 4 illustrate the relative positioning of one or more platforms with respect to the openings provided in the supporting slab 21. Thus, the supporting slab 21, generally made of 90 cm-thick concrete, is pierced at regular intervals by holes or openings such as the openings 21a, 21b and 21c, for example 80 cm long and 40 cm wide, which are used for passing the ducts and cables between the upper space above the supporting slab 21 and the lower space below the supporting slab 21.

The figures illustrate three possible positionings for the vacuum pumping system or systems.

The first positioning is illustrated in connection with the vacuum pumping systems 15 and 16, supported side by side on a platform 1 itself carried by the feet such as the feet 17, 18, 19 and 20, and held directly above the opening 21c of the supporting slab 21.

The second arrangement is illustrated in connection with the vacuum pumping devices 115 and 116, carried by a platform 101 above a solid area 21d of the supporting slab 21, between the openings 21a and 21b.

A third arrangement is illustrated in connection with the vacuum pumping devices 215 and 216, disposed above an opening but oriented transversely compared with the previous vacuum pumping systems 15 and 16.

One advantage of the rectangular shape of the platform 1 is to give a certain freedom in the choice of the horizontal position of the pumping system or systems 15 and 16 on the platform 1, in order to place the pumping system or systems 15 and 16 facing a false floor tile 100 and in the two orientations described above, irrespective of the relative position of the openings 21a, 21b, 21c.

Consideration is now given to FIG. 5, illustrating in perspective a mobile lifting frame 22, which makes it possible to position the vacuum pumping systems on the platforms 1 and to remove them under satisfactory safety conditions.

The mobile lifting frame 22 comprises two longitudinal members 23 and 24 linking the upper ends of four support legs 25, 26, 27 and 28 having directional castors 29, 30, 31, 32. The directional castors 29 and 32 can be locked pivot-wise. The directional castors 30 and 31 can be locked rotation-wise.

The longitudinal members 23 and 24 are linked by two cross members 33 and 34 carrying slide rails 35 and 36 on which there slides a movable carriage 37 carrying a winch 38.

The carriage 37 can be moved in a continuous manner by operation of a handle 39 driving a pinion 40 engaged on a rack 41.

The winch 38 acts on a cable 42, the lower end of which is fixed to a T-shaped linking component 43, itself having fixing holes 43b, 43c, 43d at the ends of its branches for attaching a vacuum pumping system. The cable 42 is connected to the T-shaped linking component 43 in an adjustable central area 43a, allowing balancing.

The mobile lifting frame 22 is constructed with materials compatible with the cleanliness class of a clean room, and does not produce any particles. It forms a straddling framework, the dimensions of which are chosen so that it can straddle a false floor tile in order to position or remove a pumping system and so as to be able to move easily between the various items of equipment installed in the clean room.

The winch 38 can raise and lower the vacuum pumping system in complete safety, the directional castors 30 and 31 then being locked rotation-wise.

The present invention is not limited to the embodiments which have been explicitly described, but includes the various variants and generalisations thereof which are within the capability of persons skilled in the art.

What is claimed is:

1 - A device for the integration of a vacuum pumping system in the intermediate space between a supporting slab and a clean room false floor formed from a juxtaposition of false floor tiles held by false floor tile support posts resting on the supporting slab, this device comprising:
a platform, whose size is greater than the floor space requirement of the vacuum pumping system to be integrated and substantially equal to that of a false floor tile;
means for holding the platform, parallel and away from the supporting slab, and at a distance from the false floor by a height greater than the height of the vacuum pumping system to be integrated.

2 - A device as claimed in claim 1, wherein the platform is held up in position by four support blocks each having a jaw gripping a false floor tile support post and having a connecting part gripping the platform.

3 - A device as claimed in claim 2, wherein the connecting part comprises a shaft protruding vertically upwards and fitting into a corresponding lower housing of the platform.

4 - A device as claimed in claim 3, wherein the corresponding lower housing of the platform is a hole in the central branch of a U-section fixed on the under-face of the platform.

5 - A device as claimed in claim 3, wherein the platform comprises, for its being kept in position by four support blocks, three oblong holes and one round hole.

6 - A device as claimed in claim 2, wherein each support block comprises an elastic and damped intermediate link, opposing the transmission of vibrations from the vacuum pumping system to the false floor.

7 - A device as claimed in claim 1, wherein the platform is held up by four feet that are independent of the means of holding up the false floor tiles and that rest on the supporting slab.

8 - A device as claimed in claim 7, wherein the feet have length-adjustment means, for adapting the vertical position of the platform.

9 - A device as claimed in claim 7, wherein the platform is approximately 650×560 mm in size, while the feet are disposed in a square with a side of approximately 480 mm and in a position off-centred as regards the length.

10 - A device as claimed in claim 1, wherein the platform comprises a continuous sheet edged with a continuous upper peripheral rim, the whole constituting a liquid retaining tank.

11 - A device as claimed in claim 1, wherein the platform bears a polymer mat, interposed between the platform and the vacuum pumping system or systems.

12 - A device as claimed in claim 1, wherein the platform carrying one or two vacuum pumping systems is held above an opening of the supporting slab.

13 - A device as claimed in claim 1, wherein the platform carrying one or two vacuum pumping systems is held above a solid area of the supporting slab, between the openings.

14 - A device as claimed in claim 1, this device comprising a mobile lifting frame, with four support legs having directional castors and having a height greater than that of a vacuum pumping system to be integrated, and with two cross members with slide rails on which there slides a movable carriage carrying a winch.

15 - A device as claimed in claim 14, wherein the winch acts on a cable that carries a T-shaped linking component, connected by its adjustable central area to the end of the cable, and having fixing holes at the ends of its branches for attaching the vacuum pumping system.

16 - A semiconductor manufacturing plant, comprising a clean room with a false floor and a supporting slab and a vacuum pumping system, wherein the vacuum pumping system is supported by a device as claimed in claim 1, with an intermediate support platform in the intermediate space between the supporting slab and the false floor, freeing a portion of space underneath the vacuum pumping system for the passage of cables and ducts and mechanically isolating the vacuum pumping system with respect to the false floor.
